(19) United States
(12) Patent Application Publication
(10) Pub. No.: US 2012/0237904 A1
(43) Pub. Date: Sep. 20, 2012

(54) Interactive Educational Mat

(76) Inventor: Paula Alicea, Windsor Locks, CT (US)

(21) Appl. No.: 13/423,337

(22) Filed: Mar. 19, 2012

Related U.S. Application Data
(60) Provisional application No. 61/453,994, filed on Mar. 18, 2011.

(51) Int. Cl. G09B 19/00

(52) U.S. Cl. 434/128

(57) ABSTRACT

An architecture is presented that provides an interactive device for use as a children's educational tool. The interactive device is designed to provide feedback in response to a child indicating a desired design element on the interactive device. The interactive device comprises a mat with pressure sensing elements associated with a plurality of design elements. When the child selects the appropriate design element, the pressure sensing element activates a control element which provides feedback such as an audio response or a visual indicator.

### CROSS-REFERENCE

This application claims priority from Provisional Patent Application Ser. No. 61/453,994 filed Mar. 18, 2011.

### FIELD OF THE INVENTION

This invention pertains generally to a learning tool for children, and more particularly to an interactive electronic mat for teaching children a variety of educational subjects.

### BACKGROUND

Many parents want their children to start learning at an early age. However, it can be difficult to teach a young child colors, shapes, numbers, letters, and the like. Many of the educational tools that are available, such as books and videos, do not hold or keep the child's attention. Children remain better engaged when the information is presented in an interactive and entertaining manner.

Consequently, there exists a need for an interactive and entertaining device for keeping the attention children for educational purposes. The present invention discloses an interactive floor mat for use as a learning tool for infants and small children. The device is useful in teaching shapes, colors, sounds, numbers, letters, animals, and the like. Children, particularly toddlers, will enjoy stepping on the interactive floor mat to experience the variety of different sounds and words that are emitted. The device is available as a series of interactive mats designed to teach a variety of educational and/or entertaining subjects. Children and parents will appreciate the entertaining style of education provided by the invention.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an interactive device for use in early childhood education and development. The interactive device comprises mat element, a plurality of pressure sensing elements, a control element, and an indicating device. The mat element may comprise a variety of different themes, such as vehicles, letters, numbers, animals, shapes, and the like. Additionally, the indicating device, such as a spin dial, may be spun to indicate one of a plurality of objects that are displayed on the spin dial. The indicated object will designate a corresponding substantially identical object for the child to locate on the mat element. For example, if the indicating element designates a picture of a star, the child will be directed to a picture of a star located on the mat element.

Furthermore, once the child locates and steps on the corresponding object on the mat element, the corresponding element will provide feedback in the manner of a visual and/or audible indication such as a light and a noise. In addition, the interactive device is usable with or without the indicating device. The child would simply receive feedback from any of a plurality of design elements integrated into the mat element.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of an interactive device in accordance with the disclosed architecture.

FIG. 2 illustrates a perspective overhead view of the interactive device in accordance with the disclosed architecture.

FIG. 3 illustrates a close up view of an indicating device for use with the interactive device in accordance with the disclosed architecture.

FIG. 4A illustrates a an overhead view of the interactive device in a different shape and design in accordance with the disclosed architecture.

FIG. 4B illustrates a an overhead view of the interactive device in a different shape and design in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

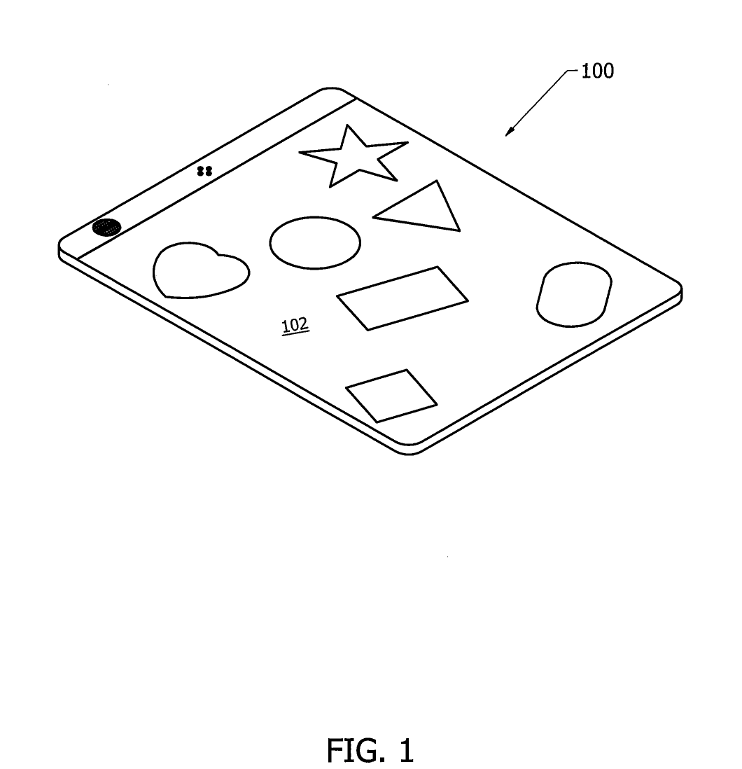

Referring initially to the drawings, FIG. 1 illustrates an interactive device 100 for use generally in early childhood education and entertainment. The interactive device 100 comprises a mat element 102 typically for use by a child in conjunction with a caregiver, such as a parent or teacher, for childhood educational development. The interactive device 100 encourages interaction by the child, thereby increasing the learning potential. Additionally, the interactive device 100 provides feedback to a user in an entertaining manner in the form of visual displays, sounds, vibrations, music, language, and the like.

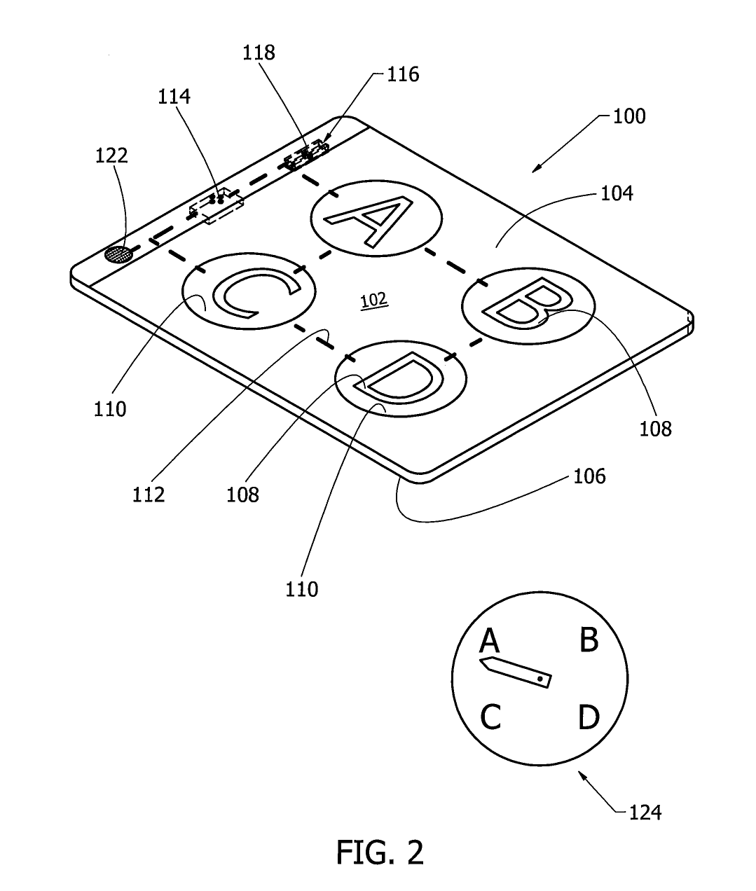

As illustrated in FIG. 2, the mat element 102 comprises a first layer 104 and a second layer 106. The mat element 102 is generally comprised of a flexible plastic, such as poly vinyl chloride sheeting, although any other suitable, durable material may be used to manufacture the mat element 102 as is known in the art without affecting the overall scope of the invention such as rubber, plastic, polyethylene, fabric, polymers, nylon, and the like. These materials are advantageous as they are generally soft, lightweight, washable, easy to clean, and durable. Similarly, these materials allow the mat element 102 to be portable as the mat element 102 may easily roll and/or fold up for storage and/or transport. Furthermore, the first layer 104 and the second layer 106 may have smooth, textured, antibacterial, antimicrobial and/or slip resistant properties.

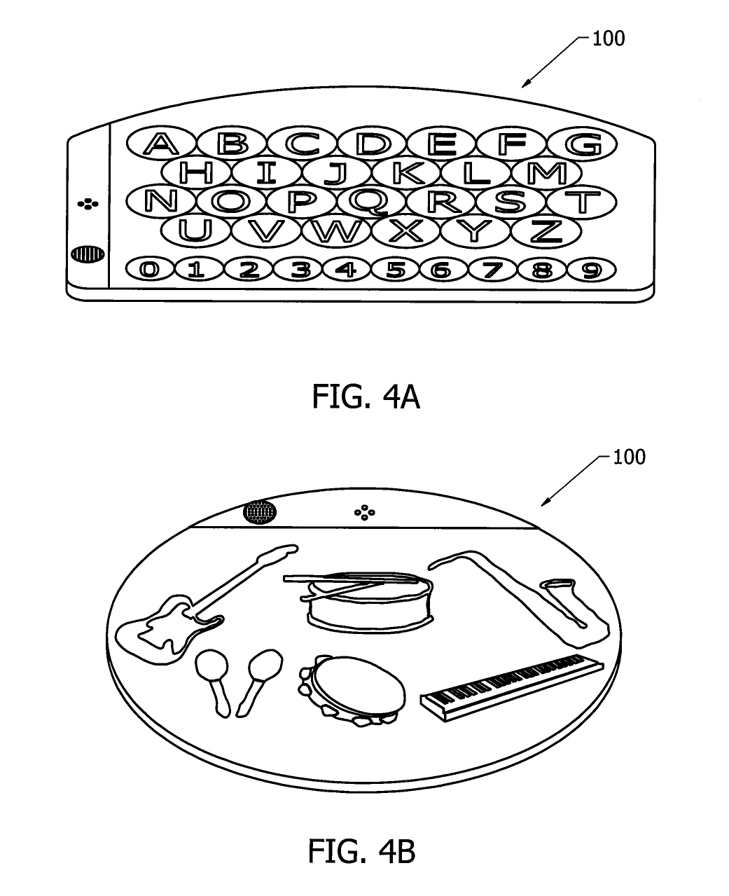

As illustrated in FIGS. 4A and 4B, the mat element 102 may be configured in a variety of shapes as desired for the specific educational purpose. Preferred shapes of the mat element 102 include a rectangle, a square, an oval, a circle, an octagon, a polygon, a star shape, and the like; however this is not meant as a limitation as the mat element 102 can be any shape, design or size as is known in the art without affecting the overall scope of the invention. For example, the embodiment illustrated in FIG. 1 shows the mat element 102 in a generally rectangular shape with rounded corners that is approximately between four and six feet long and approximately between two and four feet wide. Additionally, the mat element is preferably approximately between 1/16^{th} and ¾^{th} inches in thickness.

As illustrated in FIG. 2, the interactive device 100 further comprises a plurality of design elements 108. The plurality of design elements 108 preferably comprise numbers, letters, shapes, words, objects, pictures, and the like; however this is not meant as a limitation as the plurality of design elements 108 may be of any desirable design useful for education and/or entertainment purposes. For example, in one embodiment, the plurality of design elements 108 could comprise pictures of people in different professions such as a doctor, a police officer, a firefighter, a pilot, a teacher, and the like. Other embodiments may comprise themes such as pictures and/or designs relating to sports, nature, safety, and the like. The plurality of design elements 108 are typically attached to or embedded within the first layer 104 of the mat element 102. For example, the plurality of design elements 108 may be attached to the mat element 102 by sewing, radio-frequency welding, heat, adhesive, paint, and the like, or by any other method of attaching known to one of skill in the art.

The interactive device 100 further comprises a plurality of pressure sensing elements 110 attached to or embedded in the mat element 102. The plurality of pressure sensing elements 110 comprises at least one sensing component that is preferably activated by pressure, such as from a child's foot. Additionally, the plurality of pressure sensing elements 110 are integrated with the plurality of design elements 108. In other words, every one of the plurality of design elements 108 will typically be connected to one of the plurality of pressure sensing elements 110. The plurality of pressure sensing elements 110 are typically located within the mat element 102 between the first layer 104 and the second layer 106 generally approximately underneath the plurality of design elements 108, however any method of locating and integrating the plurality of pressure sensing elements 110 known to one of skill in the art is acceptable.

The interactive device 100 further comprises a control element 114. The control element 114 is integrally connected to the plurality of pressure sensing elements 110. Typically, a plurality of wiring elements 112 are located within the mat element 102 between the first layer 104 and the second layer 106 connecting the plurality of pressure sensing elements 110 to the control element 114. Similarly, the control element 114 is typically located within mat element 102 between the first layer 104 and the second layer 106. Additionally, while the preferred embodiment shows that the control element 114 is in communication electrically with the plurality of pressure sensing elements 110 through the plurality of wiring elements 112, the communication may also be wireless as well, such as but not limited to radio frequency signals for example.

As one of the plurality of pressure sensing elements 110 is activated, a signal is sent to the control element 114 which in turn provides a response to the activation. The response is typically an audio and/or visual feedback. However, the response may be feedback comprising but not limited to a sound, a light, music, audible words, a vibration, and the like, or any combination thereof, without affecting the overall scope of the invention. The interactive device 100 further comprises a speaker element 122 connected to the control element 114 to provide audible feedback stored in the control element 114. For example, as the child activates one of the plurality of pressure sensing elements 110, the speaker element 122 may emit a stored recorded sound or noise that relates to the corresponding one of the plurality of design elements 108 selected by the child. Additionally, the control element 114 comprises a power source 116, preferably a battery 118 or an external electrical plug in cord (not shown).

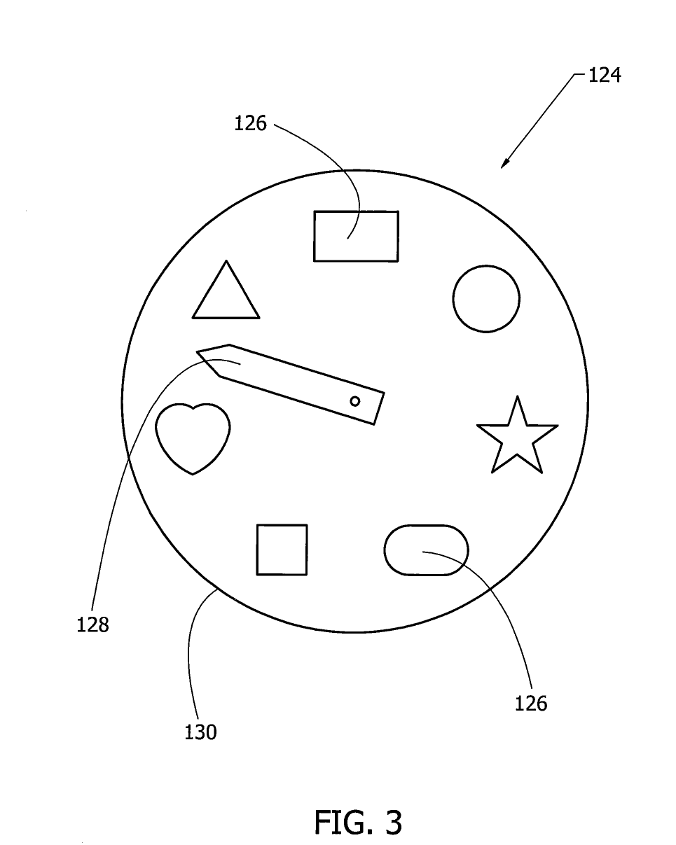

As illustrated in FIGS. 2 and 3, the interactive device 100 further comprises an indicating device 124. The indicating device 124 is typically a spin dial 130 comprising a plurality of corresponding design elements 126 and a pointer 128; however this is not meant as a limitation as any method of indicating including but not limited to a remote controller, a pointer, and a push button type indicator may be used without affecting the overall scope of the invention. In the preferred embodiment the plurality of corresponding design elements 126 comprise smaller examples of the plurality of design elements 108 that are part of the mat element 102. Therefore, the caregiver or the child simply spins the pointer 128 and matches the indicated one of the corresponding design elements 126 to a matching one of the plurality of design elements 108. When the child activates by pressing or stepping on the matching one of the plurality of design elements 108, the child is rewarded with the response in the form of feedback as discussed supra.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An interactive device comprising:
a mat element;
at least one sensing component connected to the mat element;
a control component integrally connected to the at least one sensing component, wherein the control component provides a response when the at least one sensing component is activated; and
an indicating component.

2. The interactive device of claim 1, wherein the mat element comprises a flexible material.

3. The interactive device of claim 2, the flexible material comprises at least one of the following materials: rubber, plastic, fabric, poly vinyl chloride, polymer, or nylon.

4. The interactive device of claim 1, wherein the mat element is configured in at least one of the following shapes: a rectangle, a square, an oval, a circle, an octagon, a polygon, or a star.

5. The interactive device of claim 1, further comprising a speaker element connected to the control component.

6. An interactive device for use by a child, the interactive device comprising:
a mat element comprising a first layer and a second layer;
a plurality of pressure sensing elements attached to the mat element;
a control element in communication with the plurality of pressure sensing elements, wherein the control element provides a response when at least one of the plurality of pressure sensing elements are activated by the child; and
an indicating component.

7. The interactive device of claim 6, wherein the mat element is approximately between 1/16^{th} and ¾^{th} inches in thickness.

8. The interactive device of claim 6, wherein the first layer and the second layer comprise a slip resistant surface.

9. The interactive device of claim 6, wherein the plurality of pressure elements are in electrical communication with the control element.

10. The interactive device of claim 6, wherein the plurality of pressure elements are in wireless communication with the control element.

11. The interactive device of claim 6, wherein the response is at least one of the following: a sound, a light, music, audible words, or a vibration.

12. The interactive device of claim 6, wherein the plurality of pressure sensing elements are integrated with a plurality of design elements.

13. The interactive device of claim 6, wherein the interactive device is portable.

14. An interactive device for use in childhood development, the interactive device comprising:
a mat element comprising a first layer and a second layer;
a plurality of pressure sensing elements embedded within the mat element, wherein the plurality of pressure sensing elements are integrated with a plurality of design elements; and
a control element in communication with the plurality of pressure sensing elements, wherein the control element provides feedback when the plurality of pressure sensing elements are activated; and
an indicating device for choosing one of the plurality of design elements.

15. The interactive device of claim 14, wherein the feedback provided by the control element comprises visual and audio feedback.

16. The interactive device of claim 14, wherein the indicating device comprises a spin dial.

17. The interactive device of claim 14, wherein the control element comprises a power source.

18. The interactive device of claim 17, wherein the power source comprises a battery.

19. The interactive device of claim 17, wherein the power source comprises an electrical cord.

20. The interactive device of claim 14, wherein the plurality of design elements comprise at least one of the following: a letter, a number, a word, an animal shape, an object, a musical instrument shape, a shape, and a picture.
